(19) United States
(12) Patent Application Publication
(10) Pub. No.: US 2019/0056523 A1
(43) Pub. Date: Feb. 21, 2019

(54) ELECTRO ACOUSTIC TECHNOLOGY SEISMIC DETECTION SYSTEM WITH DOWN-HOLE SOURCE

(71) Applicant: Halliburton Energy Services, Inc., Houston, TX (US)

(72) Inventors: Mikko Jaaskelainen, Katy, TX (US); Brian V. Park, Spring, TX (US); Norman R. Warpinski, Cypress, TX (US)

(21) Appl. No.: 15/759,138

(22) PCT Filed: Dec. 16, 2015
(86) PCT No.: PCT/US2015/065964

§ 371 Date: Mar. 9, 2018

(51) Int. Cl. G01V 1/46; G01V 1/22; G01V 1/20

(52) U.S. Cl. CPC G01V 1/46; G01V 1/208; G01V 1/226

(57) ABSTRACT

A device is described for downhole seismic sensing utilizing electro acoustic technology in conjunction with moveable downhole seismic sources.

### BACKGROUND

Seismic sensing systems continue to be an important part of oil and gas well monitoring. The placement of seismic sensors in high temperature wells has been a challenge from a cost, reliability, and service life. Current systems often require electrical cables, electrical sensors, AID converters, computers or data acquisition units and telemetry circuits with electronics capable of these high temperatures with good reliability and service life. Complex digital electronic circuits fail and/or have poor service life at elevated temperatures, and some of the digital electronics circuits are high end and very expensive. There is also a need for better quality seismic data with higher frequency content when compared with existing systems.

An emerging new technology, electro acoustic technology, has created an opportunity to address these ongoing needs. A novel seismic sensing system with high fidelity and high signal-to-noise that can be used with down-hole seismic sources deployed inside a well-bore is now a possibility.

This disclosure will describe a new approach for this application.

### BRIEF DESCRIPTION OF THE DRAWINGS

FIG. 1 illustrates the basic concept of electro acoustic technology.

FIG. 2 illustrates a more complete system for utilizing electro acoustic technology in a subsurface well.

FIG. 3 illustrates an embodiment of a seismic detection system proposed herein.

FIG. 4 illustrates an electro seismic technology (EAT) detector that can be used in this proposal.

FIG. 5 illustrates an alternate embodiment of a seismic detection system proposed herein.

FIG. 6 illustrates an alternate embodiment of a seismic detection system proposed herein.

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

The detailed description to follow describes the use of electro acoustic technology to create a new type of seismic detection system. Electro acoustic technology (EAT) will be described first and then the use of EAT in creating this seismic detection system.

### Description of EAT (Electro Acoustic Technology) Sensors

The EAT sensors and EAT sensing technology described in this disclosure is a recently developed technology and has been described in a recently published PCT application: WO2015020642A1.

EAT Sensors represent a new approach to fiber optic sensing in which any number of downhole sensors, electronic or fiber optic based, can be utilized to make the basic parameter measurements, but all of the resulting information is converted at the measurement location into perturbations or a strain applied to an optical fiber that is connected to an interrogator that may be located at the surface of a downhole well. The interrogator may routinely fire optical signal pulses downhole into the optical fiber. As the pulses travel down the optical fiber back scattered light is generated and is received by the interrogator.

The perturbations or strains introduced to the optical fiber at the location of the various EAT sensors can alter the back propagation of light and those effected light propagations can then provide data with respect to the signal that generated the perturbations.

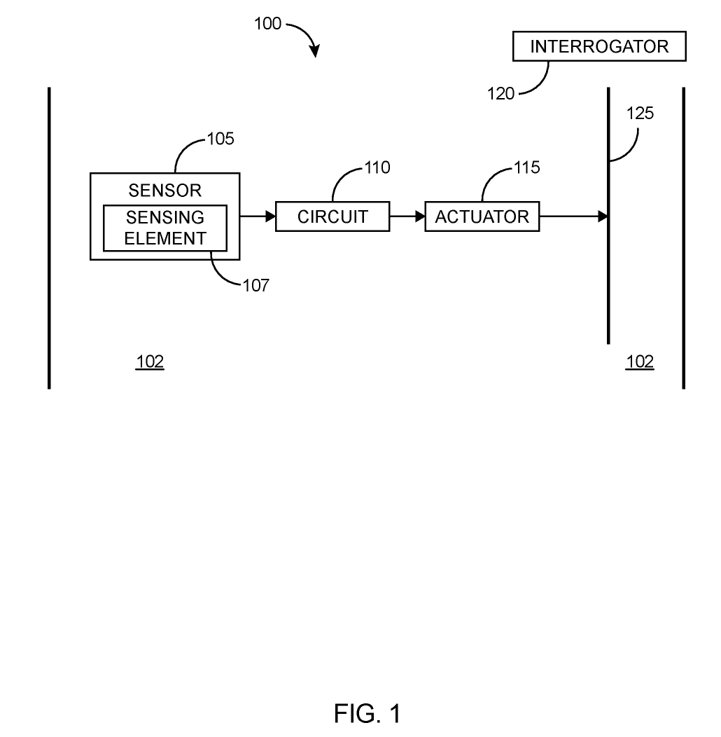

The EAT sensor system can be best understood by reference to FIG. 1, which is an example embodiment of an EAT sensor system. System 100 can include a sensor 105, a circuit 110 coupled to the sensor 105, an actuator 115 coupled to the circuit 110, and an interrogator 120. The sensor 105 is operable to provide a measurement corresponding to a parameter at a location in a region 102. The sensor 105 can be realized in a number of different ways depending on the parameter to be determined by the measurement using the sensor 105. The parameter can include, but is not limited to, a chemical concentration, a pH, a temperature, a vibration, or a pressure. The sensor 105 has the capability of being disposed at a location in proximity of an optical fiber cable 125. The sensor 105 can be located downhole at a drilling site with the interrogator 120 at the surface of the drilling site. The drilling site may be terrestrial or sea-based. Components of the system 100 may be disposed outside casing in cement or strapped to a production tube in a permanent installation. Components of the system 100 also may be disposed in a coiled tube that can be pushed through into a horizontal area of operation, or a wire line cable that can be tractored into a wellbore using an electrically driven tractor that pulls the wire line cable into the wellbore, or pumped into a wellbore with fluid that push/pulls a cable into the wellbore. The system 100 may be used with other drilling related arrangements. The circuit 110, coupled to the sensor 105, can be structured to be operable to generate a signal correlated to the parameter in response to the measurement by the sensor 105. The circuit 110 may be integrated with the sensor 105. For example, a sensing element 107 may be an integral part of the circuit 110 or directly coupled to a component of the circuit 110. The sensing element 107 may be a diaphragm directly coupled to a component of the circuit 110.

The actuator 115 can be coupled to the circuit 110 to receive the signal generated in response to the measurement by the sensor 105. The signal can be a compensated signal, where a compensated signal is a signal having a characteristic that corresponds to the parameter of interest for which variations in one or more other parameters is substantially corrected or removed, or for which the characteristic is isolated to the parameter of interest. The actuator 115 can be integrated with the circuit 110, integrated with the circuit 110 that is integrated with the sensor 105, or a separate structure coupled to the circuit 110.

The actuator 115 can be structured to be operable to generate a perturbation, based on the signal, to an optical fiber cable 125, that may include one or multiple optical fibers. The actuator 115 can be positioned in proximity to the optical fiber cable 125 at the effective location of the sensor 105. The actuator 115 can be structured to be operable to generate the perturbation to the optical fiber cable 125 with the actuator 115 in contact with the optical fiber cable 125. The actuator 115 can be structured to be operable to generate the perturbation to the optical fiber cable 125 with the actuator 115 a distance from the optical fiber cable 125. The actuator 115 may be realized as a non-contact piezoelectric material, which can provide acoustic pressure to the optical fiber cable 125 rather than transferring vibrations by direct contact.

The optical fiber cable 125 can be perturbed with the optical fiber cable 125 in direct contact with the actuator 115 structured as a vibrator or with the actuator 115 structured having a form of voice coil at a distance away from the optical fiber cable 125. The perturbation of the optical fiber can be provided as a vibration of the optical fiber cable 125 or a strain induced into the optical fiber cable 125. Other perturbations may be applied such that the characteristics of the optical fiber are altered sufficiently to affect propagation of light in the optical fiber cable 125. With the effects on the light propagation related to a signal that generates the perturbation, analysis of the effected light propagation can provide data with respect to the signal that generates the perturbation.

The interrogator 120 can be structured to interrogate the optical fiber cable 125 to analyze signals propagating in the optical fiber cable 125. The interrogator 120 can have the capability to couple to the optical fiber cable 125 to receive an optical signal including the effects from the perturbation of the optical fiber cable 125 and to extract a value of the parameter of the measurement in response to receiving the optical signal from the perturbation. In an embodiment, the received signal may be a backscattered optical signal. The interrogator 120 may be structured, for example, to inject a short pulse into the optical fiber cable 125. An example of a short pulse can include a pulse of 20 nanoseconds long. As the pulse travels down the optical fiber cable 125, back-scattered light is generated. Interrogating a location that is one kilometer down the fiber, backscattered light is received after the amount of time it takes to travel one kilometer and then come back one kilometer, which is a round trip time of about ten nanoseconds per meter. The interrogator 120 can include an interferometric arrangement. The interrogator 120 can be structured to measure frequency based on coherent Rayleigh scattering using interferometry, to measure dynamic changes in attenuation, to measure a dynamic shift of Brillouin frequency, or combinations thereof.

The interrogator 120 can be arranged with the optical fiber cable 125 to use an optical signal provided to the interrogator 120 from perturbing the optical fiber cable 125 at a location along the optical fiber cable 125. An arrangement different from using an optical signal backscattered from the perturbation can be utilized. For example, the optical fiber cable 125 can be structured having an arrangement selected from a fiber Bragg grating disposed in the optical fiber in vicinity of the actuator for direct wavelength detection based acoustic sensing, a non-wavelength selective in-line mirror disposed in the optical fiber in vicinity of the actuator, intrinsic Fabry-Perot interferometers as a mode of interrogation from fiber Bragg gratings placed apart in the optical fiber such that each fiber Bragg grating Fabry-Perot cavity is in vicinity of a respective actuator, Fizeau sensors in the optical fiber, a second optical fiber to transmit an optical signal from a perturbation of the optical fiber to a detection unit of the interrogator, or other arrangements to propagate a signal, representative of a measurement, in an optical fiber to an interrogation unit to analyze the signal to extract a value of a parameter that is the subject of the measurement.

The possible advantages from using the above described EAT systems in a variety of configurations may include using a variety of sensors, either electrical or fiber optic based, to measure for example a chemical concentration, a pH, a temperature, or a pressure and using a common optical fiber connected to a surface interrogator to measure perturbation signals from each EAT sensor location distributed along that common optical fiber and analyzing those signals to extract values of the parameters being measured. The approach can significantly reduce manufacturing complexity, reduce very expensive labor intensive production with expensive equipment like splicers and fiber winders, improve reliability, and widen industry acceptance by allowing the use of sensing technologies of choice.

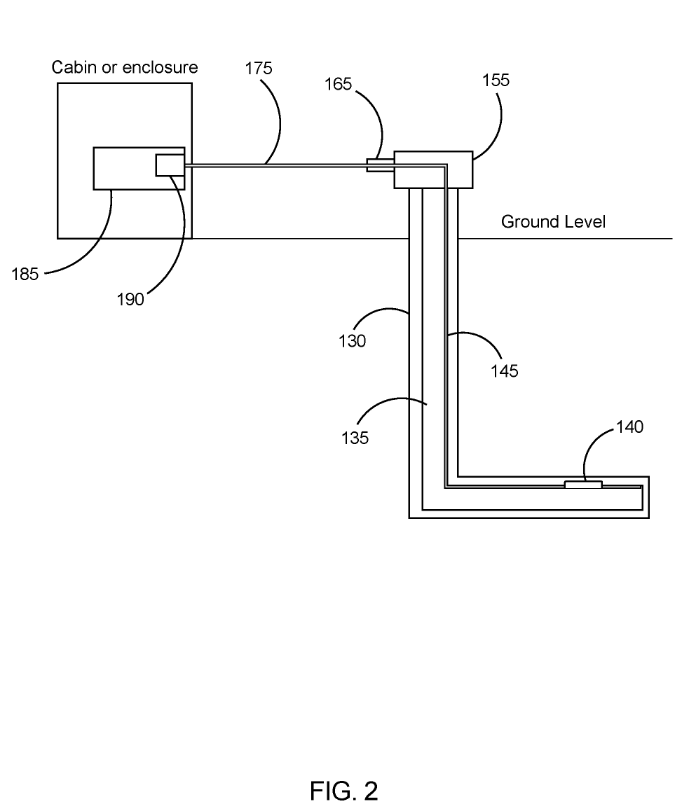

FIG. 2 expands on the use of electro acoustic technology (EAT) sensing systems by illustrating a more complete system. A subsurface well 130 is illustrated, in which a production casing 135 is shown extending through the well. In some applications the production casing may be non-metallic. At the far downhole end of the well an electro acoustic technology sensor assembly 140 is shown. In this example it is shown on the outside of the casing. In some applications the EAT sensor assembly could be within the casing. In many applications there could be multiple EAT sensor assemblies and the technology can easily accommodate that. In close proximity to the EAT sensor assembly shown is a fiber optic cable 145 that is deployed all through the well and back to the surface, then through a wellhead 155. The fiber optic cable 145 may be clamped to the EAT sensor assembly 140 to ensure good transmission of signals. The fiber optic cable 145 exits through a wellhead exit 165 and is connected using a surface fiber cable 175 within an outdoor cabin or enclosure to a Distributed Acoustic System (DAS) interrogator 185. The interrogator may then have a laser source 190 that fires interrogation pulses down through the fiber optic cable and receives backscattered light back from the fiber optic cable.

The fiber optic cable 145 may be permanently installed, or in some applications could be attached to some type of logging cable such as wireline or slickline cables. It could also be clamped on tubing inside the casing 135 in some applications.

In another embodiment of the use of electro acoustic technology a digital version of the electronics could be used in which the initial sensor is still an analog sensor but then analog to digital converters are used and the signal is continuously transmitted in a digital format. This solution would require a more costly set of electronics but still without data acquisition/timing circuitry and complex telemetry. The advantage of this approach may be a better signal to noise ratio as analog signals would have a signal to noise ratio that would decrease with distance along the optical fiber.

### Seismic Detection System with Electro Acoustic Technology

The system proposed comprises Electro Acoustic Technology (EAT) devices with seismic sensors that are placed outside a well casing and cemented in place. The EAT devices are either powered by battery and/or energy harvesting devices and/or can be equipped with coils used for inductive, charging of the battery. A fiber optic sensing cable is deployed outside the casing and attached in place, and the fiber optic cable is in close, proximity and preferably in physical contact with the EAT devices, and in particular with the transmission end.

At the surface then is a fiber optic interrogator (185 in FIG. 2) that can detect acoustic signals and/or vibrations acting on the fiber optic cable. The seismic sensors used to detect seismic waves outside of well casing and transmit the information to the surface via DAS fiber.

Finally the proposal includes a seismic source that can be deployed down-hole by e.g. pumping it down towards the distal end of the well, and then pulled back towards the surface end of the well using a wireline while periodically emitting seismic source signals. The source may have a mechanism to clamp the source to the casing on demand to provide good coupling. The seismic source may be a P-wave source and/or a Shear-wave source where the Shear-wave source may be directional and the directionality can be oriented on demand. In another embodiment the seismic source can be a combination of a P-wave and a Shear-wave source. The seismic source(s) may be deployed using slick line with a pre-programmed emission cycle or coiled tubing.

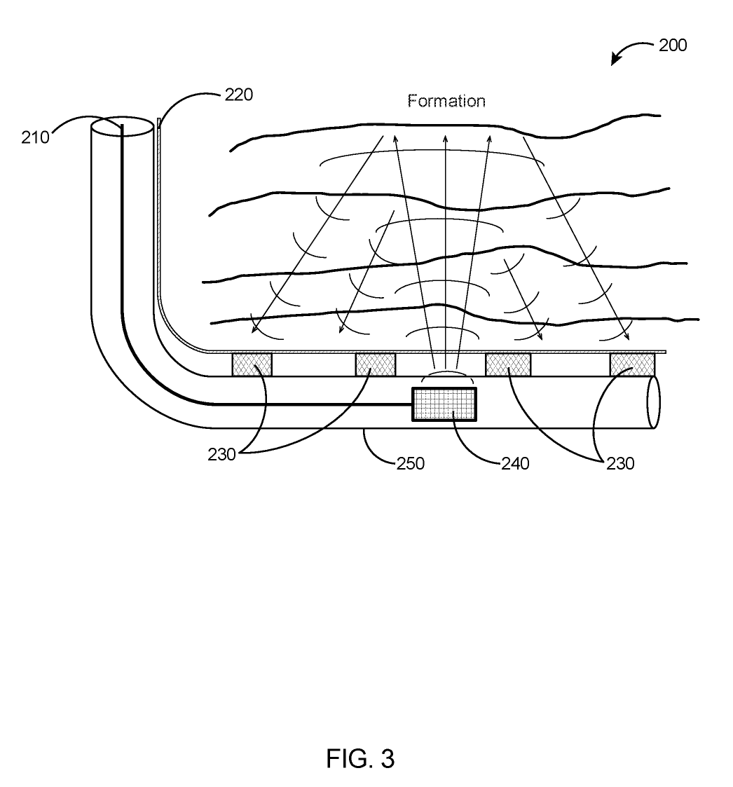

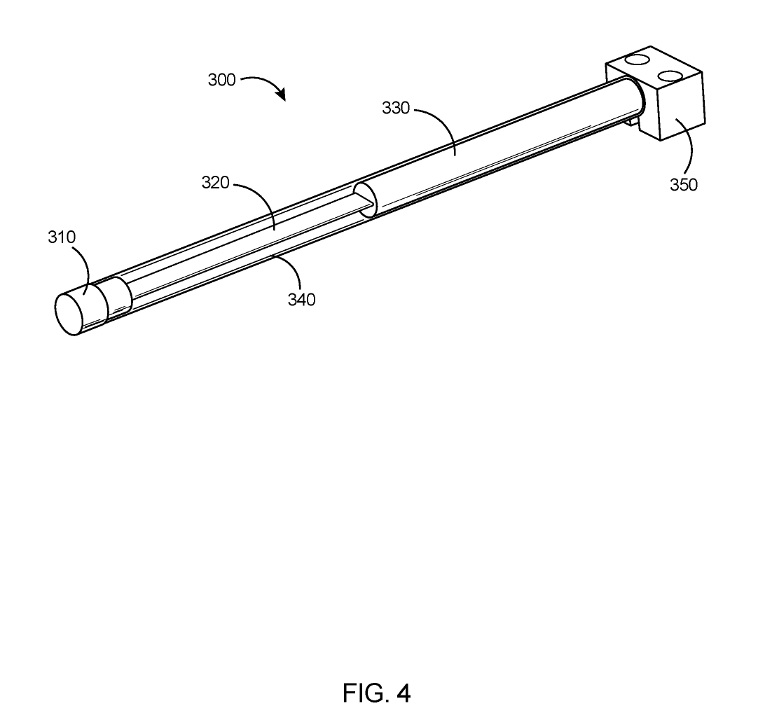

Turning now to FIG. 3, shown generally as the numeral 200, is a depiction of one embodiment of and EAT seismic detection system. A downhole casing 250 is shown with four EAT seismic sensors 230 attached in place on the casing. The EAT sensors will be described in FIG. 4. A fiber optic sensing cable 220 is deployed outside the casing and attached, possibly cemented, in place, and the fiber optic cable is in close proximity and preferably in physical contact with the EAT devices 230, and in particular with the transmission end. The fiber optic cable is eventually connected at the surface with a DAS fiber optic interrogator (illustrated in FIG. 2)). Finally this proposal includes a seismic source 240 that can be deployed down-hole by e.g. pumping it down towards the distal end of the well, and then pulled back towards the surface end of the well using a wireline 210 while periodically emitting seismic source signals.

The system in operation will transmit seismic signals down-hole from the source, and the seismic source signal may reflect off reservoir boundary layers, fluid/rock interfaces etc. and these reflected seismic signals may be detected by the seismic sensor or seismic sensors in the EAT devices. The detected seismic signals will be converted to acoustic and/or vibrational analog or digital data that may be transmitted by the EAT sensor to the fiber optic sensing cable, and the fiber optic sensing cable is then interrogated by the fiber optic sensing system and converted back to a seismic signal. The sensing system may also be used for collecting micro-seismic data during e.g. a fracture operation in the same well or during fracture operations in a neighbor well. The system may also be used together with a surface seismic source where data can be taken between fracture stages to evaluate stimulated reservoir volume by monitoring changes in seismic signal travel time as the formation characteristics may change when large amounts of frac fluids are pumped into the various frac stages.

Turning now to FIG. 4, shown generally as the numeral 300, is an illustration of an electro acoustic technology seismic detector of the types 230 shown in FIG. 3. The seismic detection sensor 310 at one end, may house single axis or multi-axis geophones, accelerometers or other devices capable of detecting seismic signals. An electronics section 320 and a battery section 330 are enclosed in a pressure housing 340. A clamp 350 may be used to clamp the EAT assembly to the fiber optic cable 220 of FIG. 3. The seismic signals from the seismic detector sensor 310 are converted into e.g. a voltage signal that can be used to drive e.g. a piezo-electric transponder, and the piezo-electric transponder may then be acoustically and/or mechanically coupled to the sensing cable. The acoustic and/or vibrational signals are then coupled into the cable and into the fiber(s), and the fiber is interrogated from the surface using a fiber optic sensing system capable of detecting the signals. The raw data is collected and converted to seismic data. The data may be filtered and decimated to match the characteristics of the source and/or the expected frequency content of the events of interest.

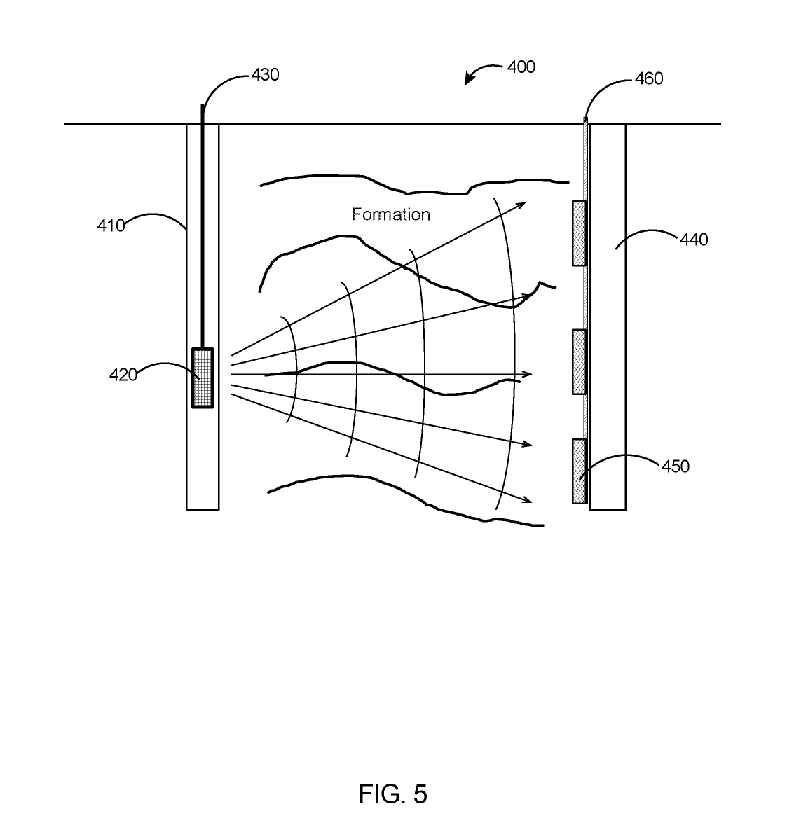

Other embodiments illustrating the use of EAT technology in conjunction with a downhole source are shown in the next two figures. FIG. 5, shown generally as numeral 400, illustrates a casing 440 with installed EAT sensors 450 attached on the outside of the casing and a separate casing 410 with a downhole acoustic source 420 controlled in this example by a wireline 430. The EAT sensors 450 are in close proximity or attached to a fiber optic cable 460 in communication with a distributed acoustic sensing interrogator on the surface.

This system in operation will transmit seismic signals down-hole from the source 420 in casing 410, and the seismic source signal may reflect off reservoir boundary layers, fluid/rock interfaces etc. and these reflected seismic signals may be detected by the seismic sensor or seismic sensors in the EAT devices 450. The detected seismic signals will be converted to acoustic and/or vibrational analog or digital data that may be transmitted by the EAT sensors to the fiber optic sensing cable 460, and the fiber optic sensing cable is then interrogated from the surface by the distributed fiber optic sensing system and converted back to a seismic signal.

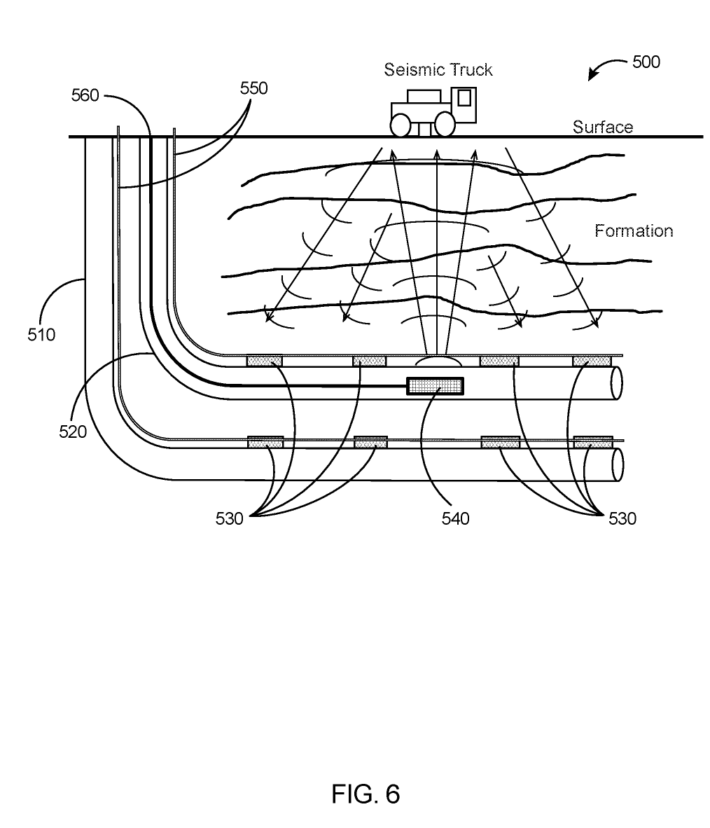

FIG. 6 is yet another embodiment in which two downhole casings 510, 520 have EAT sensors 530 in place attached to the outside of the casings and one of the casings 520 contains an internal movable seismic source 540 controlled in this example by a wireline 560. This movable source could also by controlled by a slickline. In this embodiment a second seismic source, a seismic truck, can also be used to transit seismic signals through the formation.

Both the internal seismic source 540 and the seismic truck can transmit seismic signals down-hole and the seismic source signals may reflect off reservoir boundary layers, fluid/rock interfaces etc. and these reflected seismic signals may be detected by the seismic sensor or seismic sensors in the EAT devices 530. The detected seismic signals will be converted to acoustic and/or vibrational analog or digital data that may be transmitted by the EAT sensors to two fiber optic sensing cables 550, and the fiber optic sensing cables can then interrogated from the surface by distributed fiber optic sensing systems and converted back to a seismic signal.

### Advantages of the Proposed System

The application of using Electro acoustic technology (EAT) in this configuration has not been done in the industry. Earlier attempts to place sensors down-hole in high temperature wells required electrical cables, electrical sensors, AID converters, computers or data acquisition units and telemetry circuits with electronics capable of these high temperatures with good reliability and service life. Complex digital electronic circuits fail and/or have poor service life at elevated temperatures, and some of the digital electronics circuits are high end and very expensive. The EAT sensors may use analog electronics with better reliability and service life at elevated temperatures.

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

1. A system for downhole seismic sensing comprising:
a. multiple electro acoustic technology seismic sensors attached to the outside of downhole casings;
b. one or more fiber optic sensing cables installed on the outside of the downhole casings and in close proximity with the multiple electro acoustic technology seismic sensors;
c. one or more surface fiber optic interrogators to detect acoustic signals acting on the fiber optic sensing cables;
d. a movable seismic source that to move down the interior of the downhole casings and to pull back while periodically emitting seismic source signals; and
e. a source of electrical power to the multiple electro acoustic technology seismic sensors.

2. The system for downhole seismic sensing of claim 1 wherein the multiple electro acoustic technology seismic sensors comprise:
a. electrical seismic sensing elements;
b. electronic circuits to convert the detected acoustic signals to frequencies;
c. amplification circuitry to amplify the frequencies; and
d. an acoustic source to convert the amplified frequencies to an acoustic frequency signal;

3. The system for downhole seismic sensing of claim 2 wherein the electrical seismic sensing elements comprise at least one of geophones, accelerometers, hydrophones, analog electrical seismic sensing elements, digital electrical seismic sensing elements.

4. (canceled)

5. (canceled)

6. (canceled)

7. (canceled)

8. The system for downhole seismic sensing of claim 1 wherein the source of electrical power to the multiple electro acoustic technology seismic sensors comprises at least one of a battery and an internal energy harvesting device.

9. (canceled)

10. The system for downhole seismic sensing of claim 1 wherein the movable seismic source is to moved down by pumping and to pull back by wireline.

11. The system for downhole seismic sensing of claim 1 wherein the movable seismic source using slick line with a pre-programmed emission cycle.

12. The system for downhole seismic sensing of claim 1 wherein the movable seismic source is a P-wave source.

13. The system for downhole seismic sensing of claim 1 wherein the movable seismic source is a Shear-wave source where the Shear-wave source is directional and the directionality is oriented on demand.

14. The system for downhole seismic sensing of claim 1 wherein the movable seismic source is a combination of P-wave and a Shear-wave source.

15. The system for downhole seismic sensing of claim 1 wherein two or more casings are downhole and the movable seismic source is deployed in at least one of the casings to emit seismic signals into a formation that are to be sensed by the electro acoustic technology seismic sensors attached to other casings.

16. The system for downhole seismic sensing of claim 15 further comprising a surface source of seismic signals.

17. (canceled)

18. A method for downhole seismic sensing comprising:
a. providing multiple electro acoustic technology seismic sensors attached to the outside of one or more downhole casings;
b. providing a source of electric power to the multiple electro acoustic technology seismic sensors;
c. providing one or more fiber optic sensing cables installed on the outside of the one or more downhole casings and in close proximity with the multiple electro acoustic technology seismic sensors;
d. providing a surface fiber optic interrogator for detecting acoustic signals acting on the fiber optic sensing cables;
e. providing a movable seismic source that is to move down the interior of at least one of the downhole casings and to pull back while periodically emitting seismic source signals; and
f. converting the detected acoustic signals to seismic signals.

19. The method for downhole seismic sensing of claim 18 wherein the multiple electro acoustic technology seismic sensors utilize electrical seismic sensing elements.

20. The method for downhole seismic sensing of claim 18 wherein the multiple electro acoustic technology seismic sensors utilize analog electrical seismic sensing elements.

21. The method for downhole seismic sensing of claim 18 wherein the multiple electro acoustic technology seismic sensors utilize analog electrical seismic sensing elements and the signals are converted to digital signals with analog to digital converters.

22. The method for downhole seismic sensing of claim 18 wherein the source of electrical power to the multiple electro acoustic technology seismic sensors comprises at least one of a battery and an internal energy harvesting device.

23. (canceled)

24. The method for downhole seismic sensing of claim 18 wherein providing the movable seismic source to moved down the interior of at least one of the downhole casings and to pull back while periodically emitting seismic source signals comprises providing the movable seismic source to move down by pumping and to pull back by wireline.

25. The method for downhole seismic sensing of claim 18 wherein providing a movable seismic source that that can be moved down the interior of at least one of the downhole casings and pulled back while periodically emitting seismic source signals is moved down and pulled back using slick line with a pre-programmed emission cycle.

26. The method for downhole seismic sensing of claim 18 wherein two or more casings are provided downhole and the movable seismic source is provided in at least one of the casings to emit the seismic source signals into a formation to be sensed by electro acoustic technology seismic sensors attached to other casings.

27. The method for downhole seismic sensing of claim 26 further comprising providing a surface source of seismic signals.

28. (canceled)
